(19) United States
(12) Patent Application Publication
(10) Pub. No.: US 2010/0126614 A1
(43) Pub. Date: May 27, 2010

(54) Separated-control valve device

(76) Inventor: Tien-Ho Chung, Changhua Hsien (TW)

Correspondence Address: Chien-Hui Su, P. O. Box 70-121 Taichung, Taichung City, 40899, TW

(21) Appl. No.: 12/276,421

(22) Filed: Nov. 24, 2008

(51) Int. Cl. F16K 11/072

(52) U.S. Cl. 137/625.46

(57) ABSTRACT

A separated-control valve device includes a valve seat having a space defined therein. An inner lower periphery of the space has two inlets and two outlets are defined therein and communicated with the space. A control assembly is partially and pivotably received in the space in the valve seat. The control assembly has a first valve and a second valve for respectively adjusting water flowing from the inlet to the outlet. A limiter is mounted on the valve seat for confining the control assembly received in the space.

### BACKGROUND OF THE INVENTION

1. Field of the Invention

The present invention relates to a separated-control valve device, and more particularly to a separated-control valve device having two valves for respectively adjusting a temperature/flow of water.

2. Description of Related Art

A conventional valve device includes a housing having two inlets and an outlet formed in a bottom panel, a seat secured in the housing and having two ports and an aperture aligned with the inlets and the outlet of the housing. A rotary member is rotatably received in the housing, and engaged onto the seat, and includes a bore communicating with the aperture of the seat, and two slots selectively communicating with the ports of the seat when the rotary member is rotated relative to the housing and the seat. The seat and the rotary member are made of porcelain materials to make a water tight seal without spring members.

However, the rotary member of the conventional valve device is rotatable relative to the housing and the seat to selectively enclose/disclose the ports for guiding hot water and cold water flowing from the ports to the bore of the rotatory member. Therefore, the hot water and the cold water are relatively linked together due to the rotatory member is rotatable relative to the housing and the seat. It is hard to precisely adjust a water temperature and a water flow. Furthermore, the flows of the hot water and the cold water are linked and relatively provided. It can not separately adjust the flows of the hot water and the cold water. Thus, it is inconvenient to use the conventional valve device.

The present invention has arisen to mitigate and/or obviate the disadvantages of the conventional valve device.

### SUMMARY OF THE INVENTION

The main objective of the present invention is to provide an improved separated-control valve device for providing a valve device for separately adjusting a temperature and a flow of water.

To achieve the objective, the separated-control valve device in accordance with the present invention comprises a valve seat having a space defined therein. An inner lower periphery of the space has two inlets and two outlets respectively defined therein. Each of the two inlets and the two outlets is respectively communicated with the space. The two inlets include a first inlet and a second inlet. The two outlets include a first outlet and a second outlet. The first inlet and the second inlet are adapted to connect to a hot water tube and a cold water tube. The first outlet and the second outlet adapted to connect to a faucet. A control assembly is partially received in the space in the valve seat. The control assembly comprises a first valve and a second valve. The first valve has a first globe body pivotably received in the space and a first lever extending from a top of the first globe body. The first globe body has a first recess defined in a bottom thereof for adjustably communicating with the first inlet and the first outlet. The second valve has a second globe body pivotably received in the space and a second lever extending from a top of the second globe body. The second globe body has a second recess defined in a bottom thereof for adjustably communicating with the second inlet and the second outlet. A limiter is mounted on the valve seat for confining the first globe body and the second globe body received in the space. The limiter comprises an inner cap unrotatably mounted on the valve seat and an outer cap coated on the inner cap. The cap has an opening centrally defined therein for receiving the first lever of the first valve and the second lever of the second valve. The outer cap has a first slot and a second slot defined in a top thereof for restrictively receiving the first lever and the second lever.

The first lever and the second lever are respectively pushed to pivotally drive the first globe body and the second globe body for adjustably communicating with the first inlet and the first outlet via the first recess and adjustably communicating with the second inlet and the second outlet via the second recess. Therefore, flows of hot water and cold water are separately adjustable such that a temperature and a flow of water are adjustable.

Furthermore, a second embodiment in accordance with the present invention shows the first outlet and the second outlet respectively having an impervious unit compressively received therein for abutting against the first valve and the second valve. Each of the two impervious units has a hollow elastic seal member and a spring received in the seal member. The seal member of each of the two impervious units has a hole longitudinally defined therein for allowing water flowing in the seal member. Therefore, a space between the first globe body and the first outlet and a space between the second globe body and the second outlet are respectively sealed to prevent the water from flowing backwards.

Further benefits and advantages of the present invention will become apparent after a careful reading of the detailed description with appropriate reference to the accompanying drawings.

### BRIEF DESCRIPTION OF THE DRAWINGS

FIG. 1 is an exploded view of a separated-control valve device in accordance with the present invention;

FIG. 2 is a perspective view of the separated-control valve device in accordance with the present invention;

FIG. 3 is an operational view of the separated-control valve device in accordance with the present invention;

FIG. 4 is a cross-sectional view of the separated-control valve device in accordance with the present invention taken along line A-A in FIG. 3;

FIG. 5 is an operational view of the separated-control valve device in accordance with the present invention;

FIG. 6 is a cross-sectional view of the separated-control valve device in accordance with the present invention taken along line B-B in FIG. 5;

FIG. 7 is an exploded view of a second embodiment of a separated-control valve device in accordance with the present invention;

FIG. 8 is an operational view of the second embodiment of the separated-control valve device in accordance with the present invention; and

FIG. 9 is a cross-sectional view of the second embodiment of the separated-control valve device in accordance with the present invention taken along line C-C in FIG. 8.

### DETAILED DESCRIPTION OF THE INVENTION

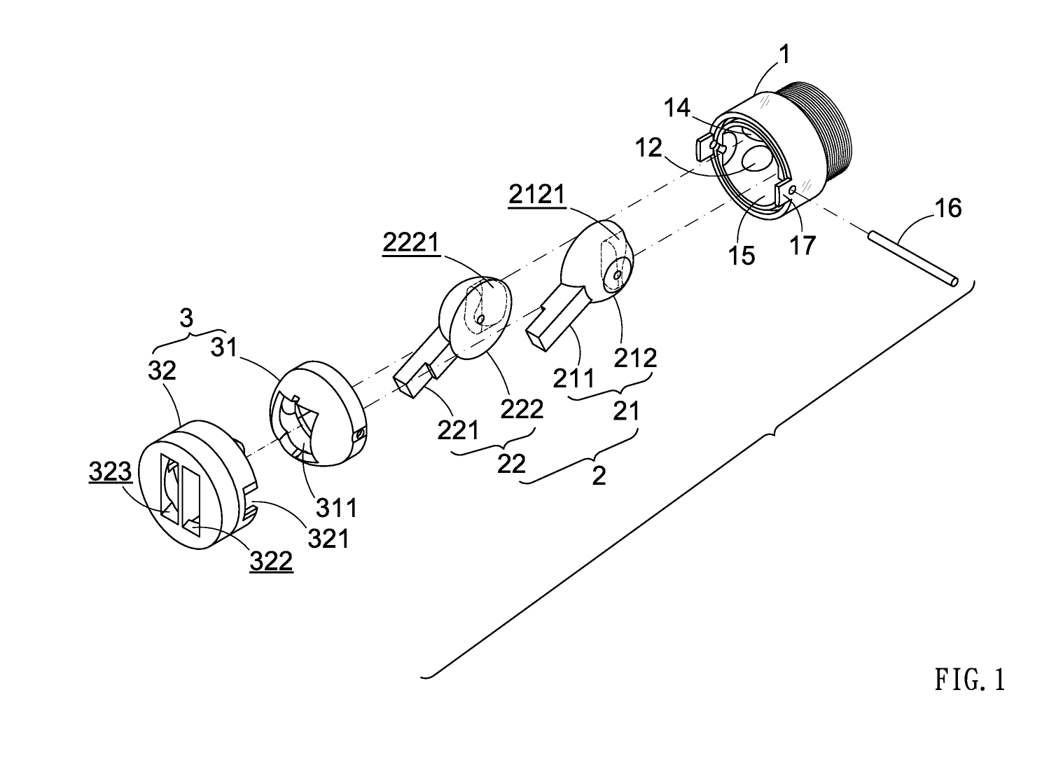

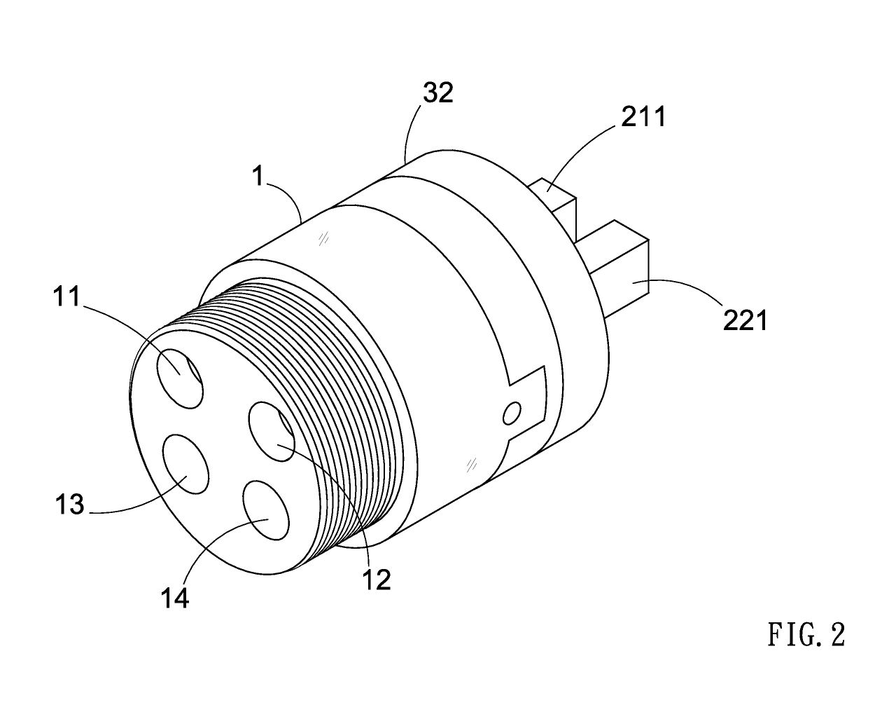

Referring to the drawings and initially to FIGS. 1-2, a first embodiment of a separated-control valve device in accordance with the present invention comprises a valve seat (1), a control assembly (2) partially received in the valve seat (1), and a limiter (3) mounted on the valve seat (1).

The valve seat (1) has a tubular structure and has a space (15) defined therein for receiving the control assembly (2). The space (15) has an inner lower periphery having two inlets respectively defined therein and two outlets respectively defined therein adjacent to the two inlets. The two inlets and the two outlets are communicated with the space (15). The two inlets include a first inlet (11) and a second inlet (12). The two outlets include a first outlet (13) and second outlet (14). The first inlet (11) and the second inlet (12) are respectively adapted to connect to a hot water tube and a cold water tube. The first outlet (13) and the second outlet (14) are adapted to connect to a faucet. Both the first outlet (13) and the second outlet (14) have a first end adjacent to the space (15) and a second end opposite to the first end. An inner diameter of the first end of the first outlet (13) and the second outlet (14) is greater than that of the second end of the first outlet (13) and the second outlet (14) for adjusting a flow speed of water. The valve seat (1) has two protrusions (17) diametrically and longitudinally extending from an edge of a top thereof.

The control assembly (2) comprises a first valve (21) and a second valve (22). The first valve (21) includes a first globe body (212), a first lever (211) extending from a top of the first globe body (212), and a first recess (2121) defined in a bottom of the first globe body (212). The first globe body (212) has a hemispherical-liked structure for smoothly pivoting in the space (15) in the valve seat (1). The first valve (21) and the second valve (22) are generally mirror images of each other. The second valve (22) includes a second globe body (222), a second lever (221) extending from a top of the second globe body (222), and a second recess (2221) defined in a bottom of the second globe body (222). The second globe body (222) has a hemispherical-liked structure.

The limiter (3) comprises an inner cap (31) unrotatably mounted on the valve seat (1) and an outer cap (32) coated on the inner cap (31). The inner cap (31) has an opening (3 11) centrally defined therein for simultaneously receiving the first lever (211) of the first valve (21) and the second lever (221) of the second valve (22). The outer cap (32) has a first slot (322) and a second slot (323) respectively defined in a top thereof for restrictively receiving the first lever (211) and the second lever (221). The first slot (322) and the second slot (323) are parallel to each other. The outer cap (32) has two notches (321) diametrically defined in an edge of a bottom thereof for corresponding to the two protrusions (17) of the valve seat (1).

When assembling, the first globe body (212) of the first valve (21) and the second globe body (222) of the first valve (21) are received in the space (15) in the valve seat (1). The inner cap (31) is mounted on the valve seat (1) for confining the first globe body (212) and the second globe body (222) received in the space (15). The first lever (211) of the first valve (21) and the second lever (221) of the second valve (22) extend from the opening (311) in the inner cap (31). A pin (16) is laterally mounted in the two protrusions (17) of the valve seat (1) via the two lateral sides of the inner cap (31), the first globe body (212), the second globe body (222) for respectively allowing the first valve (21) and the second valve (22) pivoting in the space (15) in the valve seat (1). The outer cap (32) is coated on the inner cap (31) and unrotatably mounted on the valve seat (1) due to the two notches (321) corresponding to the two protrusions (17). The first lever (211) of the first valve (21) is restrictively received in the first slot (322). The second lever (221) of the second valve (22) is restrictively received in the second slot (323).

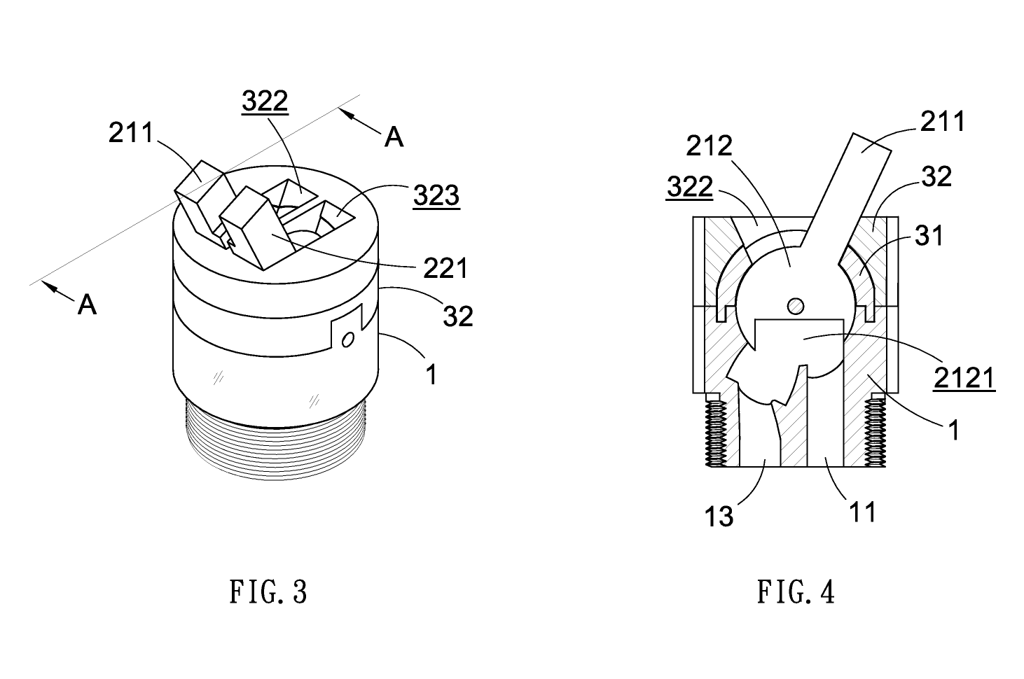

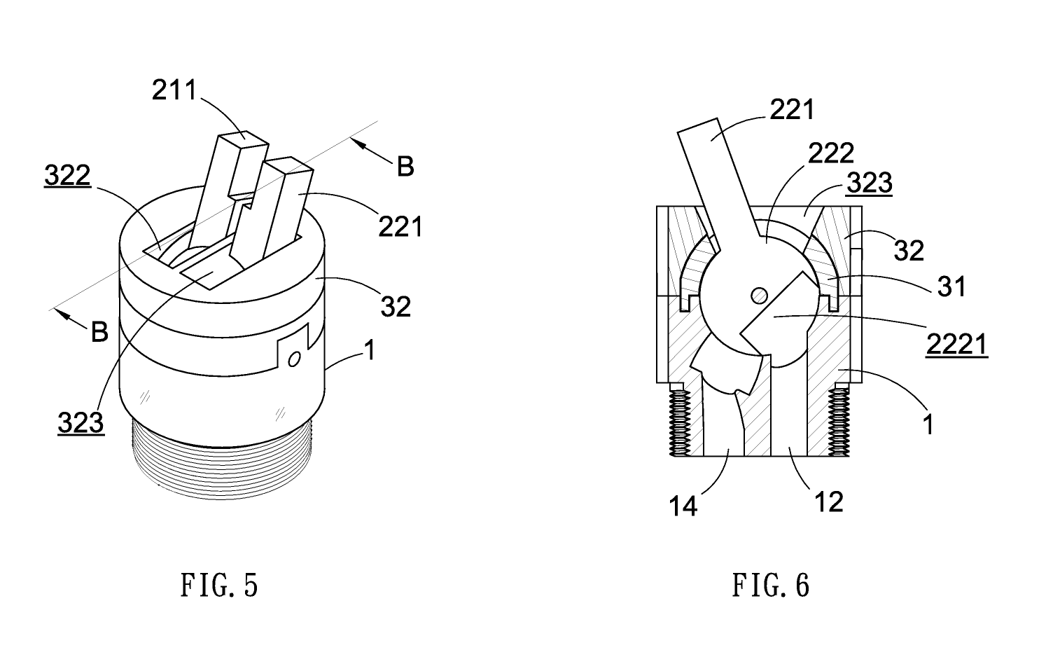

With reference to FIGS. 3-4, the first inlet (11) is connected to the hot water tube, and the second inlet (12) is connected to the cold water tube. When more hot water is required, the first lever (211) of the first valve (21) is pushed toward one end of the first slot (322) for pivoting the first globe body (212) of the first valve (21) to adjustably gradually communicate with the first inlet (11) and the first outlet (13) via the first recess (2121) in the first globe body (212) for guiding hot water from the first inlet (11) to the first outlet (13). In the same way, when more cold water is required, the second lever (221) is pushed to one end of the second slot (323), the second inlet (12) is adjustably gradually communicated with the second outlet (14) via the second recess (2221) in the second globe body (222) for guiding cold water from the second inlet (12) to the second outlet (14). With reference to FIGS. 5-6, contrariwise, when less cold water is required, the second lever (221) of the second valve (22) is pushed toward the other end of the second slot (323) in the outer cap (32) for pivoting the second globe body (222) to gradually diminish the cold water until the second outlet (14) is enclosed and the cold water is stopped flowing. In the same way, when less hot water is required, the first lever (211) of the first valve (21) is pushed toward the other end of the first slot (322) such that the first outlet (13) is gradually enclosed for diminishing the hot water. Therefore, the flows of hot water and cold water are separately adjustable to precisely adjust a temperature/ flow of water.

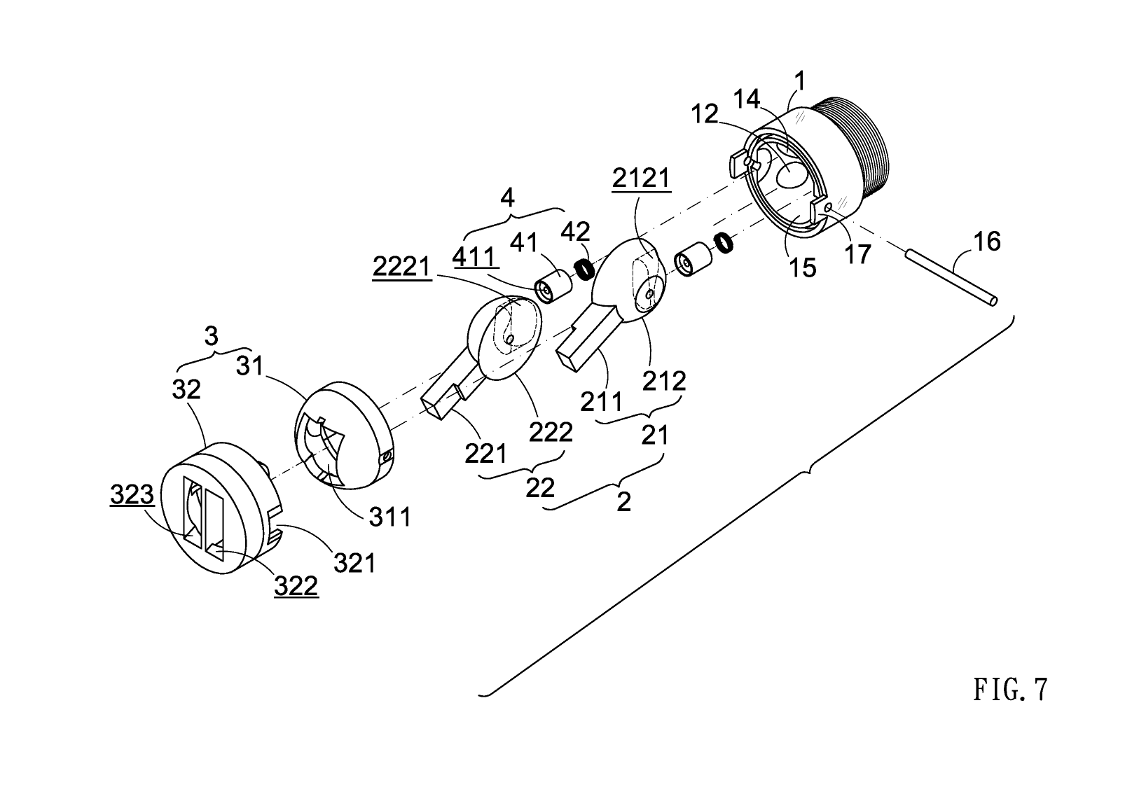

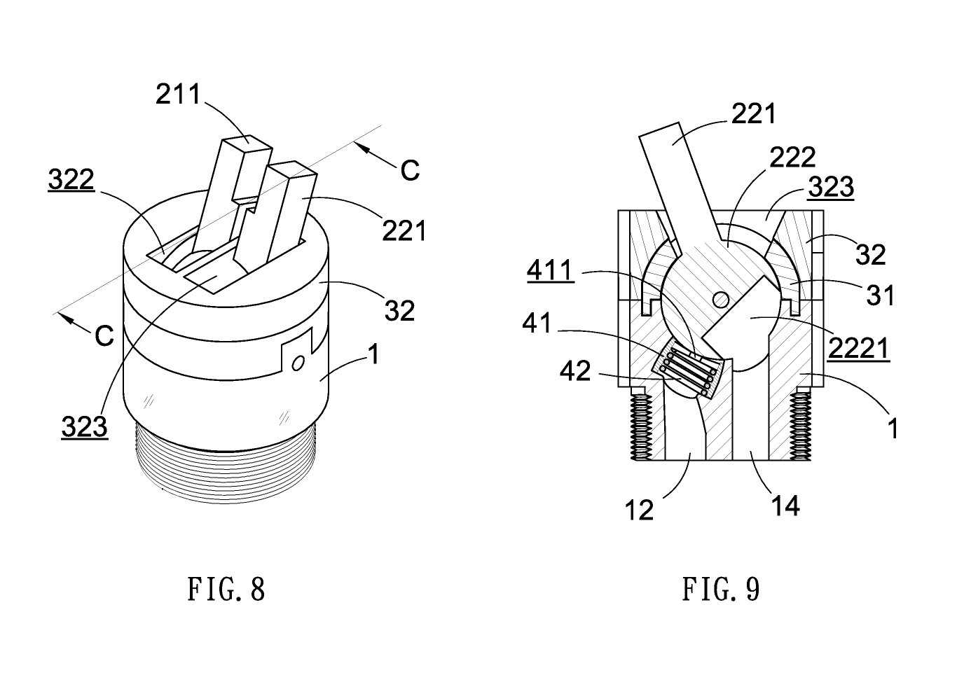

With reference to FIGS. 7-9, that shows a second embodiment of the separated-control valve device in accordance with the present invention. The elements and effects of the second embodiment which are the same with the first embodiment are not described, only the differences are described. The first outlet (13) and the second outlet (14) respectively have an impervious unit (4) compressively received therein for abutting against the first valve (21) and the second valve (22). Each of the two impervious units (4) has a hollow elastic seal member (41) and a spring (42) received in the seal member (41). Each seal member (41) has a hole (411) longitudinally defined therein for allowing water flowing in the seal member (41). Therefore, the two impervious units (4) are respectively abutted against the first globe body (212) of the first valve (21) and the second globe body (222) of the second valve (22). A space between the first globe body (212) and the first outlet (13) and a space between the second globe body (222) and the second outlet (14) are respectively sealed to prevent the water from flowing backwards.

Although the invention has been explained in relation to its preferred embodiment, it is to be understood that many other possible modifications and variations can be made without departing from the spirit and scope of the invention as hereinafter claimed.

What is claimed is:

1. A separated-control valve device comprising:
a valve seat having a space defined therein, an inner lower periphery of the space having two inlets and two outlets respectively defined therein, the two inlets and the two outlets respectively communicated with the space, the two inlets including a first inlet and a second inlet, the two outlets including a first outlet and a second outlet, the first inlet and the second inlet adapted to connect to a hot water tube and a cold water tube; the first outlet and the second outlet adapted to connect to a faucet;
a control assembly partially received in the space in the valve seat, the control assembly comprising a first valve and a second valve, the first valve having a first globe body pivotably received in the space and a first lever extending from a top of the first globe body, the first globe body having a first recess defined in a bottom thereof for adjustably communicating with the first inlet and the first outlet; the second valve having a second globe body pivotably received in the space and a second lever extending from a top of the second globe body, the second globe body having a second recess defined in a bottom thereof for adjustably communicating with the second inlet and the second outlet; and
a limiter mounted on the valve seat for confining the first globe body and the second globe body pivotably received in the space, the first valve and the second valve of the control assembly pivotally and partially disposed between the valve seat and the limiter, the first lever and the second lever extending from the limiter;
wherein the first lever is pushed to pivotally drive the first globe body for adjustably communicating with the first inlet and the first outlet via the first recess, the second lever pushed to pivotally drive the second globe body for adjustably communicating with the second inlet and the second outlet via the second recess, the first valve and the second valve separately operated such that a temperature and a flow of water are preciously adjustable.

2. The separated-control valve device as claimed in claim 1, wherein the limiter comprises an inner cap unrotatably mounted on the valve seat and an outer cap coated on the inner cap, the inner cap having an opening centrally defined therein for allowing the first lever of the first valve and the second lever of the second valve extending from the opening, the outer cap having a first slot and a second slot respectively defined in a top thereof for restrictively receiving the first lever and the second lever.

3. The separated-control valve device as claimed in claim 1 further comprising a pin laterally mounted in the valve seat via the limiter, the first globe body, and the second globe body for respectively allowing the first valve and the second valve pivoting in the space.

4. The separated-control valve device as claimed in claim 2, wherein the valve seat has two protrusions extending from an edge of a top thereof, the outer cap having two notches diametrically defined in an edge of a bottom thereof, the two notches in the outer cap corresponding to the two protrusions of the valve seat for unrotatably mounting the outer cap on the valve seat.

5. The separated-control valve device as claimed in claim 1, wherein the first outlet and the second outlet respectively have an impervious unit compressively received therein for abutting against the first valve and the second valve, each of the two impervious units having a hollow elastic seal member and a spring received in the seal member, each seal member having a hole longitudinally defined therein.

6. The separated-control valve device as claimed in claim 1, wherein both the first outlet and the second outlet have a first end adjacent to the space and a second end opposite to the first end, an inner diameter of the first end greater than that of the second end.
